(19) United States
(12) Patent Application Publication
(10) Pub. No.: US 2016/0168917 A1
(43) Pub. Date: Jun. 16, 2016

(54) CUTTING ELEMENT WITH VARIED SUBSTRATE LENGTH

(71) Applicant: Smith International, Inc., Houston, TX (US)

(72) Inventor: Michael G. Azar, The Woodlands, TX (US)

(21) Appl. No.: 14/956,796

(22) Filed: Dec. 2, 2015

Related U.S. Application Data
(60) Provisional application No. 62/090,962, filed on Dec. 12, 2014.

(51) Int. Cl. E21B 10/43; B23K 1/00; E21B 10/56

(52) U.S. Cl. CPC E21B 10/43; E21B 10/56; B23K 1/0008; E21B 2010/425

(57) ABSTRACT

A downhole cutting tool includes a tool body, a plurality of blades extending a height from the tool body to an outermost surface, and a plurality of cutting elements on at least one of the plurality of blades, each cutting element having a longitudinal axis oriented substantially radially outward from the outermost surface of the blade, and at least two adjacent cutting elements of the plurality of cutting elements having different axial lengths.

### CROSS REFERENCE TO RELATED APPLICATION

This application claims the benefit of and priority to U.S. Provisional Application 62/090,962 filed on Dec. 12, 2014, the entirety of which is incorporated herein by reference.

### BACKGROUND

In drilling a borehole in the earth, such as for the recovery of hydrocarbons or for other applications, it is conventional practice to connect a drill bit on the lower end of an assembly of drill pipe sections that are connected end-to-end so as to form a “drill string.” The bit is rotated by rotating the drill string at the surface or by actuation of downhole motors or turbines, or by both methods. With weight applied to the drill string, the rotating bit engages the earthen formation causing the bit to cut through the formation material by either abrasion, fracturing, or shearing action, or through a combination of all cutting methods, thereby forming a borehole along a predetermined path toward a target zone.

Many different types of drill bits have been developed and found useful in drilling such boreholes. Two predominate types of drill bits are roller cone bits and fixed cutter (or rotary drag) bits. Most fixed cutter bit designs include a plurality of blades angularly spaced about the bit face. The blades project radially outward from the bit body and form flow channels there between. In addition, cutting elements are typically grouped and mounted on several blades in radially extending rows. The configuration or layout of the cutting elements on the blades may vary widely, depending on a number of factors such as the formation to be drilled.

The cutting elements disposed on the blades of a fixed cutter bit are typically formed of extremely hard materials. In a typical fixed cutter bit, each cutting element includes an elongate and generally cylindrical tungsten carbide substrate that is received and secured in a pocket formed in the surface of one of the blades. The cutting elements typically include a hard cutting layer of polycrystalline diamond (PCD) or other super abrasive material such as thermally stable diamond or polycrystalline cubic boron nitride. A PCD layer is often fixed to a substrate (e.g., a cylindrical tungsten carbide substrate) to form a polycrystalline diamond compact (PDC). For convenience, “PDC bit” “PDC cutters” may be used to refer to a fixed cutter bit or cutting element employing a hard cutting layer of polycrystalline diamond or other super abrasive materials.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a downhole cutting tool that includes a tool body, a plurality of blades extending a height from the tool body to an outermost surface, and a plurality of cutting elements on at least one of the plurality of blades, each cutting element having a longitudinal axis oriented substantially radially outward from the outermost surface of the blade, at least two adjacent cutting elements of the plurality of cutting elements having different axial lengths.

In another aspect, embodiments disclosed herein relate to a downhole cutting tool that includes a tool body, a plurality of blades extending a height from the tool body to an outermost surface, a plurality of cutting elements on the plurality of blades, each cutting element having a longitudinal axis oriented substantially radially outward from the outermost surface of the blades. A rotated view of the plurality of cutting elements into a single plane forms a cutting profile including a cone region, a nose region, a shoulder region, and a gage region. The downhole cutting tool may further include least one row of cutting elements, each row having at least three of the plurality of cutting elements on the outermost surface of one of the blades and defined by a straight line intersecting the longitudinal axes of each cutting element in the row, and each row of cutting elements having a cutting row density equal to the cumulative diameter of the cutting elements forming the row in at least one region divided by a length of the at least one blade measured along the outermost surface of the at least one region of the blade. The cutting row density may be greater than 65 percent.

In yet another aspect, embodiments disclosed herein relate to a method of manufacturing a downhole cutting tool that includes attaching at least three cutting elements to at least one blade extending a height from a tool body to an outermost surface, the at least three cutting elements extending substantially radially outward from the outermost surface of the at least one blade and oriented in a row, at least two adjacent cutting elements having a different axial length.

Other aspects and advantages of the claimed subject matter will be apparent from the following description and the appended claims.

### BRIEF DESCRIPTION OF DRAWINGS

FIG. 1 shows a downhole cutting tool according to embodiments of the present disclosure.

FIG. 2 shows partial view of a blade according to embodiments of the present disclosure.

FIG. 3 shows a top view of a blade according to embodiments of the present disclosure.

FIGS. 4-7 are cross-sectional views of non-planar cutting elements according to embodiments of the present disclosure.

FIG. 8 shows overlapping profiles of cutting element orientation and positioning on a blade.

FIG. 9 shows a profile of a cutting tool as it would appear with each blade and each cutting element rotated into a single rotated profile.

FIG. 10 shows a top view of cutting element orientation and positioning on a downhole cutting tool according to embodiments of the present disclosure.

FIG. 11 shows a top view of cutting element orientation and positioning on a downhole cutting tool according to embodiments of the present disclosure.

FIG. 12 shows a top view of cutting element orientation and placement on a downhole cutting tool according to embodiments of the present disclosure.

FIG. 13 shows the cutting profile of the cutting tool shown in FIG. 12 as it would appear with each cutting element rotated into a single rotated profile.

FIG. 14 is a cross sectional view of a non-planar cutting element disposed on a blade according to embodiments of the present disclosure.

FIG. 15 shows backrake angles for cutters according to embodiments of the present disclosure.

FIGS. 16 and 17 show backrake angles for non-planar cutting elements according to embodiments of the present disclosure.

FIG. 18 shows siderake angles for cutters according to embodiments of the present disclosure.

FIGS. 19 and 20 show siderake angles for non-planar cutting elements according to embodiments of the present disclosure.

FIG. 21 shows cutting elements on a blade.

### DETAILED DESCRIPTION

In one aspect, embodiments disclosed herein relate to fixed cutter drill bits or other downhole cutting tools containing two or more cutting elements having substrates with different lengths. Other embodiments disclosed herein relate to fixed cutter drill bits containing such cutting elements, including the placement of such cutting elements on a bit and variations on the cutting elements that may be used to improve or optimize drilling.

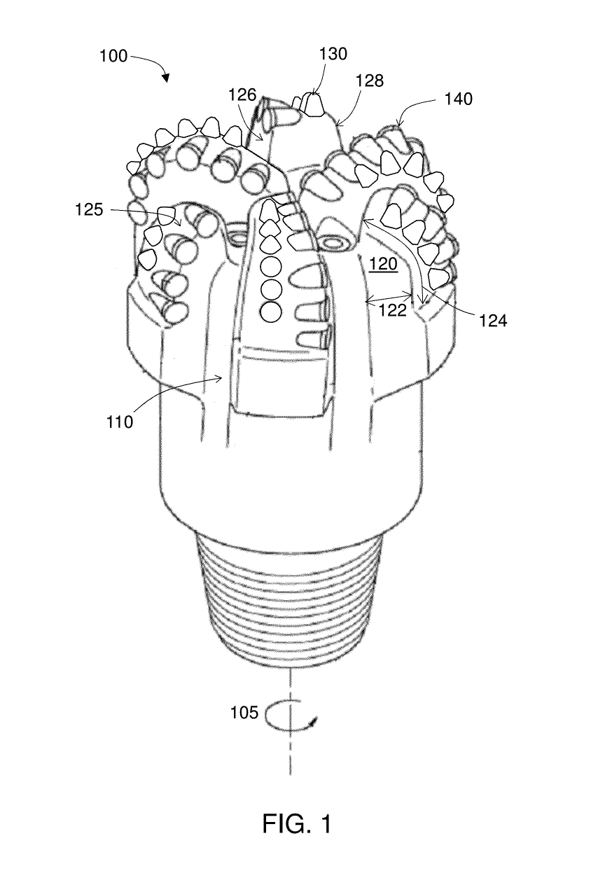

FIG. 1 shows an example of a downhole cutting tool according to embodiments of the present disclosure. In the embodiment shown, the downhole cutting tool is a fixed cutter drill bit. However, other embodiments may include other downhole cutting tool types, for example, hybrid drill bits, reamers, mills, and other downhole opening devices having one or more blades or cutting structures extending from a tool body. The downhole cutting tool 100 has a tool body 110 and a plurality of blades 120 extending a height 122 from the tool body 110 to an outermost surface 125, where the height 122 of each blade 120 along a length 124 of the blade defines a height-dimension plane. Each blade 120 may further have a width measured between a leading face 126 (i.e., the face of the blade facing in the direction of rotation 105 of the cutting tool) and a trailing face 128 (i.e., the face of the blade opposite the leading face 126) of the blade 120. A plurality of cutting elements 130 are disposed along at least one of the blades 120 and oriented substantially along the height-dimension plane of the blade 120, such that a longitudinal axis of each cutting element is oriented to extend substantially radially outward from the outermost surface 125 of the blade 120. Although not shown in FIG. 1, in some embodiments, a support (e.g., formed of the same material as the blade or from a supporting matrix material different than the blade) may at least partially surround the circumference or outer perimeter of a cutting element oriented substantially radially outward from the outermost surface of a blade. At least two adjacent cutting elements 130 disposed in a row of cutting elements 130 along a blade 120 may have different axial lengths.

Further, a plurality of primary cutting elements 140 may also disposed on the blades 120. In the embodiment shown, each blade 120 has a leading row of primary cutting elements 140 and a trailing row of at least three of the cutting elements 130. As used herein, a leading row and trailing row may refer to rows of cutting elements positioned relative to each other on a single blade 120 and relative to the leading face 126 or trailing face 128 of the blade 120, where a leading row of cutting elements is closer to the leading face 126 of the blade than the trailing row and the trailing row of cutting elements is closer to the trailing face 128 of the blade than the leading row. Likewise, a “primary cutting element” may refer to a cutting element positioned closer to the leading face of the blade relative to a trailing cutting element. In the embodiment shown in FIG. 1, the leading row of primary cutting elements 140 is positioned along a cutting edge of the blade, where the cutting edge of a blade is defined at the intersection or transition of the leading face 126 of the blade to the outermost surface 125 of the blade 120. Further, each of the primary cutting elements 140 is shown having a planar cutting face. However, other embodiments may include primary cutting elements having a non-planar cutting face or a combination of primary cutting elements having a non-planar cutting face and primary cutting elements having a planar cutting face. In addition, in some embodiments, all cutting elements may have a non-planar cutting face.

Other embodiments may include a leading row and trailing row on less than each of the blades of a cutting tool, and some embodiments may include a single row of cutting elements on each blade. Further, one or more rows of cutting elements (e.g., a leading row, trailing row, or single row) on a cutting tool according to embodiments of the present disclosure may have cutting elements oriented to have their longitudinal axes extend substantially along the height dimension of the blade on which they are disposed. That is, the one or more cutting elements may extend at an angle from the height dimension of the blade such that the axial alignment the cutting elements extend substantially radially outward from the outermost surface of the blade, while one or more or no cutting elements may be oriented substantially along the width dimension of the blade on which they are disposed. For example, in the embodiment shown in FIG. 1, each leading row includes primary cutting elements 140 oriented to substantially align with the width dimension of the blade 120, their length extending partially along the outermost surface 125 of the blade 120, and each trailing row includes cutting elements 130 oriented substantially along the height dimension of the blade 120.

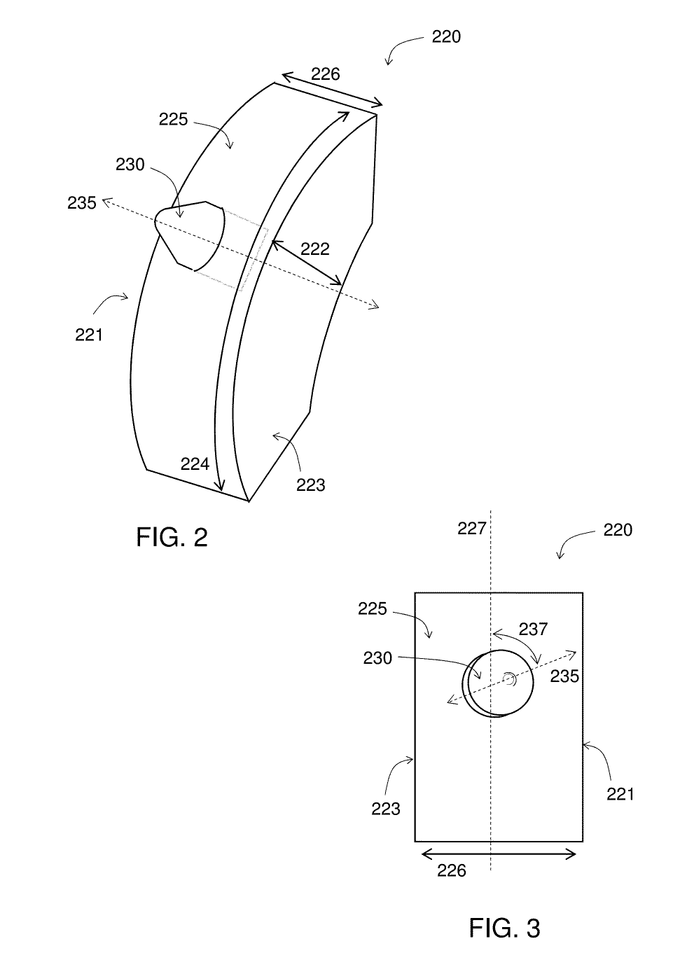

FIGS. 2 and 3 show a perspective view and top view, respectively, of another example of a cutting element oriented to have its longitudinal axis extend substantially radially outward from a blade outermost surface, where the cutting element is tilted from the height-dimension plane. As shown, a blade 220 has a height 222 measured from a cutting tool body (from which the blade may be attached to or formed integrally with) to an outermost surface 225, a length 224 measured along the outermost surface 225, and a width 226 measured between a leading face 221 and trailing face 223 of the blade 220. The height 222 of the blade 220 along a length 224 of the blade defines a height-dimension plane 227. In other words, a height-dimension plane 227 is defined as a plane extending in the height and length dimensions at a given point along the blade width. A cutting element 230 is disposed on the outermost surface 225 of the blade 220 (e.g., a top surface) and may be oriented along the height-dimension plane of the blade or at an angle relative to the height-dimension plane, such that a longitudinal axis 235 of the cutting element forms an angle 237 with the height-dimension plane ranging from about −30 degrees to about 30 degrees (e.g., has a backrake of about −30 degrees to about 30 degrees). In some embodiments, the angle 237 may be 0 degrees, where the longitudinal axis 235 of the cutting element is parallel with the blade height dimension. Further, the cutting element may be tilted in a direction towards the leading face of the blade or in a direction towards the trailing face of the blade. For example, as shown in FIG. 3, the cutting element 230 is oriented such that its longitudinal axis 235 extends substantially radially outward from the blade outermost surface 225 and tilted towards the leading face 221 of the blade 220 at angle 237 from the height-dimension plane 237 of the blade, giving it a positive angle (e.g., a positive backrake). In addition, as will be discussed in more detail, the axis of the cutter may be angled within the height-dimension plane (e.g., a siderake).

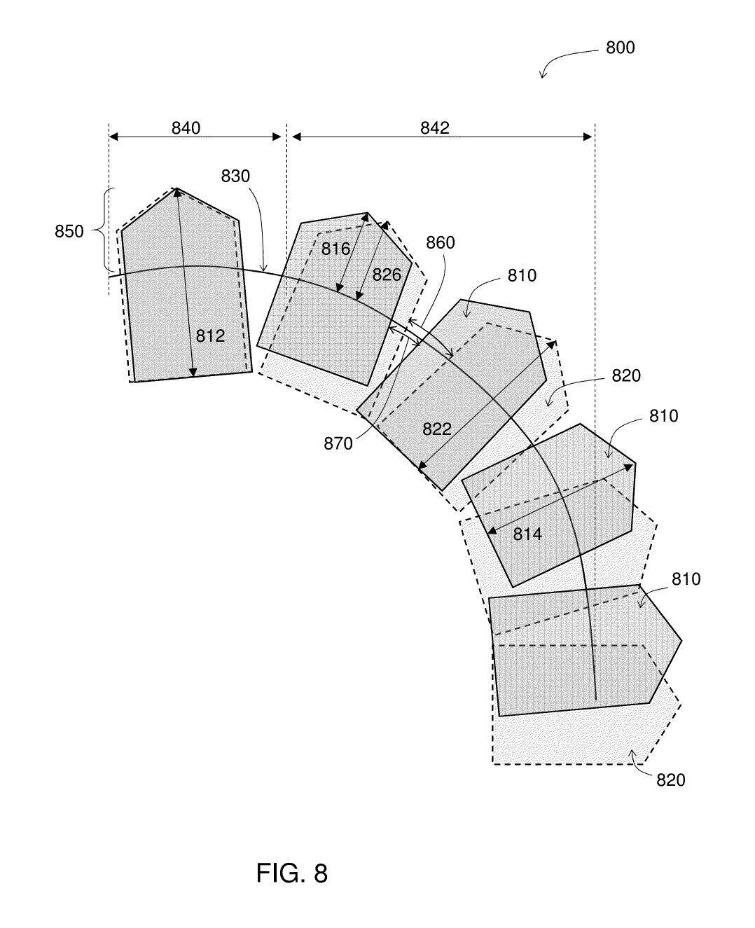

As used herein, a cutting element oriented with its longitudinal axis extending “substantially” outward from a blade outermost surface (e.g., a top surface) may include a cutting element oriented with its longitudinal axis extending along the height-dimension plane of the blade, normal to the blade profile, or may include a cutting element oriented to be tilted or deviated from a line normal to the blade profile, e.g., oriented at a back rake and/or side rake. Back rake and side rake orientations are discussed in detail below. For example, FIG. 8 shows cutting elements 810, 820 oriented with their longitudinal axes extending substantially outward from a blade outermost surface 830. Stated another way, if a plane were to be drawn tangent to the blade profile (formed by the blade outermost surface 830) at the longitudinal axis of each cutting element, the cutting elements 810, 820 oriented substantially outward from the blade outermost surface 830 may have longitudinal axes extending normal to the blade profile tangent plane or may have longitudinal axes tilted or deviated from the line normal to the tangent plane, e.g., by a selected back rake and/or side rake (discussed below).

Further, in the embodiment shown in FIGS. 2 and 3, the cutting element 230 has a non-planar cutting surface with a substantially pointed shape, where a longitudinal axis 235 extends centrally through the cutting element 230 along its axial length and through the pointed tip of the non-planar cutting surface. However, other cutting elements may have planar or other non-planar cutting face geometries with a longitudinal axis extending centrally through the cutting element along its axial length. In some embodiments, the central longitudinal axis may not pass through a tip of the non-planar cutting surface, and in still other embodiments, the non-planar cutting surface may not have a single pointed tip.

For ease in distinguishing between the multiple types of cutting elements, the term “cutting elements” will generically refer to any type of cutting element, while “cutter” will refer those cutting elements with a planar cutting face, and “non-planar cutting element” will refer to those cutting elements having a cutting end with a non-planar cutting face extending above a grip or base region, where the cutting end geometry may include but is not limited to, dome shaped cutting ends, generally pointed cutting ends, saddle shaped cutting ends, or chisel shaped cutting ends. As used herein, a non-planar cutting end of a non-planar cutting element is defined by the non-planar working or cutting face, while a grip region refers to the remaining region of the non-planar cutting element axially adjacent the non-planar cutting end. A diamond or other ultrahard material body may form both the non-planar cutting end and a portion of the grip region of the non-planar cutting element, or, a grip region may be formed entirely of a substrate, and the non-planar cutting end formed entirely of a diamond or other ultrahard material body. In other embodiments, a grip region may be formed of a combination of materials, for example, one or more substrate materials such as transition metal carbides, one or more transition layers including varying ratios of carbide and diamond mixtures, or a combination of substrate material, one or more transition layers and a portion of the material also forming the non-planar cutting end. Further, a non-planar cutting element may include a substantially cylindrical grip region, or a non-planar cutting element may include a grip region with a non-cylindrical shape.

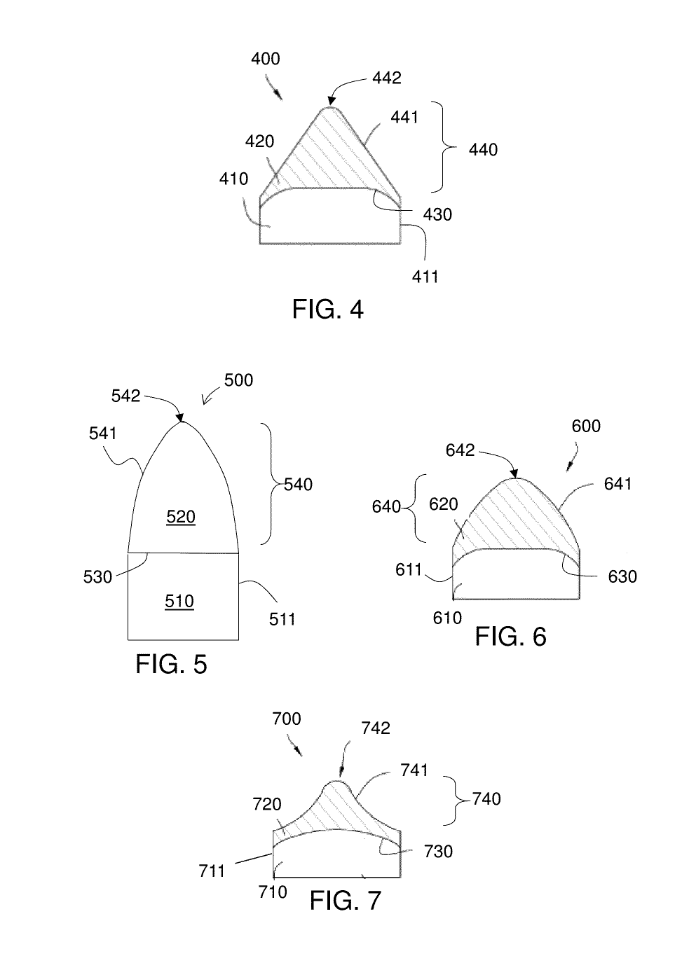

A non-planar cutting element having a generally pointed cutting end has a cutting end terminating in an apex, and may include cutting elements having a conical cutting end (such as shown in FIG. 4) or a bullet cutting element (e.g., having convex side surfaces, such as shown in FIGS. 5 and 6), for example. As used herein, the term “conical cutting elements” refers to cutting elements having a generally conical cutting end (including either right cones or oblique cones). Conical cutting elements could include geometric cones that terminate at a sharp point apex, geometric cones that terminate at a flat top, or elements having an apex having curvature between the side surfaces and the apex. For example, as shown in FIG. 4, a conical cutting element 400 has a substrate 410 and an ultrahard material body 420 disposed on the substrate 410 at a non-planar interface 430. In other embodiments, an ultrahard material body, e.g., a polycrystalline diamond (PCD) body or a PCD body that has been at least partially leached to form a thermally stable polycrystalline diamond (TSP) portion, may be disposed on a substrate at a planar interface. The ultrahard material body 420 forms a non-planar cutting end 440 having a conical side surface 441 extending from the cutting element circumferential outer surface 411 and terminating in a rounded apex 442.

In one or more embodiments, a bullet cutting element may be used. The term “bullet cutting element” refers to cutting element having, instead of a generally conical side surface, a generally convex side surface terminated in a rounded apex. For example, FIGS. 5 and 6 show bullet cutting elements 500, 600 having a substrate 510, 610 and an ultrahard material body 520, 620 disposed on the substrate at an interface 530, 630. The ultrahard material bodies 520, 620 form non-planar cutting ends 540, 640 having a generally convex side surface 541, 641 extending from the cutting element circumferential outer surface 511, 611 and terminating in a rounded apex 542, 642. In one or more embodiments, the apex 542, 642 has a substantially smaller radius of curvature than the convex side surface 541, 641. However, it is also intended that the non-planar cutting elements of the present disclosure may also include other shapes, including, for example, a concave side surface terminating in a rounded apex. FIG. 7 shows an example of a non-planar cutting element having an ultrahard material body 720 disposed on a substrate 710 at a non-planar interface 730. A non-planar cutting end 740 of the cutting element has a concave side surface 741 extending from the cutting element circumferential outer surface 711 and terminating in a rounded apex 742. In some embodiments, the non-planar cutting elements may have a smooth transition between the side surface and the rounded apex (i.e., the side surface or side wall tangentially joins the curvature of the apex), and in other embodiments, a non-smooth transition may be present (i.e., the tangent of the side surface intersects the tangent of the apex at a non-180 degree angle, such as for example ranging from about 120 to less than 180 degrees). Further, in one or more embodiments, the non-planar cutting elements may include any shape having a cutting end extending above a grip or base region, where the cutting end extends a height that is at least 0.25 times the diameter of the cutting element (e.g., the height of the portion that is less than the diameter of the grip, i.e., the tapered portion of the cutting element that includes the outermost tip, may extend above the grip, i.e., the portion of the cutting element that includes the substrate, at least 0.25 times the diameter of the cutting element at the largest diameter of the portion of the cutting element that includes the substrate), or at least 0.3, 0.4, 0.5, or 0.6 times the diameter in one or more other embodiments.

As mentioned above, the apex of the non-planar cutting element may have curvature, including a radius of curvature. In one or more embodiments, the radius of curvature may range from about 0.050 to 0.16. One or more other embodiments may use a radius of curvature of with a lower limit of any of 0.050, 0.060, 0.075, 0.085, or 0.100 and an upper limit of any of 0.075, 0.085, 0.095, 0.100, 0.110, 0.125, or 0.160, where any lower limit can be used with any upper limit. In some embodiments, the curvature may comprise a variable radius of curvature, a portion of a parabola, a portion of a hyperbola, a portion of a catenary, or a parametric spline. Further, in one or more embodiments, the different apex curvatures may be used in (the same geometry-type or different geometry type) cutting elements along a cutting profile. This may include, for example, the various embodiments described above, as well as embodiments including all conical cutting elements, or all bullet cutting elements, etc., along a cutting profile. Specifically a “blunt” cutting element may include any type of non-planar cutting element having a larger radius of curvature as compared to another, “sharp” non-planar cutting element on the same bit. Thus, the terms blunt and sharp are relative to one another, and the radius of curvatures of each may selected from any point along the radius range discussed above.

Non-planar cutting elements may be formed in a process similar to that used in forming diamond enhanced inserts (used in roller cone bits) or by brazing components together. The interface between a diamond layer (or other ultrahard material body) and a substrate (e.g., a cemented metal carbide substrate such as tungsten carbide) may be non-planar or non-uniform, for example, to aid in reducing incidents of delamination of the diamond layer from the substrate when in operation and to improve the strength and impact resistance of the element. One skilled in the art would appreciate that the interface may include one or more convex or concave portions, as known in the art of non-planar interfaces. Additionally, one skilled in the art would appreciate that use of some non-planar interfaces may allow for greater thickness in the diamond layer in the tip region of the layer. Further, it may be desirable to create the interface geometry such that the diamond layer is thickest at a zone that encompasses the primary contact zone between the cutting element and the formation. Additional shapes and interfaces that may be used for cutting elements of the present disclosure include those described in U.S. Patent Publication No. 2008/0035380, which is herein incorporated by reference in its entirety. In one or more embodiments, an ultrahard material layer may have a thickness of 0.100 to 0.500 inches from the apex to the central region of the substrate, and in one or more particular embodiments, such thickness may range from 0.125 to 0.275 inches. The ultrahard material layer and an attached cemented metal carbide substrate may have a total thickness of 0.200 to 0.700 inches from the apex to a base of the cemented metal carbide substrate. However, other sizes and thicknesses may also be used.

Further, an ultrahard material body may be formed from any polycrystalline superabrasive material, including, for example, polycrystalline diamond, polycrystalline cubic boron nitride, thermally stable polycrystalline diamond (formed either by treatment of polycrystalline diamond formed from a metal such as cobalt or polycrystalline diamond formed with a metal having a lower coefficient of thermal expansion than cobalt).

PCD may be formed by subjecting diamond particles in the presence of a suitable solvent metal catalyst material to processing conditions of high pressure/high temperature (HPHT), where the solvent metal catalyst promotes desired intercrystalline diamond-to-diamond bonding between the particles, thereby forming a PCD structure. Particularly, a microstructure of conventionally formed PCD material includes a plurality of diamond grains that are bonded to one another to form an intercrystalline diamond matrix first phase. The catalyst/binder material, e.g., cobalt, used to facilitate the diamond-to-diamond bonding that develops during the sintering process is dispersed within the interstitial regions formed between the diamond matrix first phase. The catalyst/binder material used to facilitate diamond-to-diamond bonding can be provided in the form of a raw material powder that is pre-mixed with the diamond particles or grit prior to sintering. In some embodiments, the catalyst/binder can be provided by infiltration into the diamond material (during HPHT processing) from an underlying substrate material to which the final PCD material is to be bonded. After the catalyst/binder material has facilitated the diamond-to-diamond bonding, the catalyst/binder material may be distributed throughout the diamond matrix within interstitial regions formed between the bonded diamond grains. The term “particle” refers to the powder employed prior to sintering a superabrasive material, while the term “grain” refers to discernable superabrasive regions subsequent to sintering, as known and as determined in the art. The resulting PCD structure produces enhanced properties of wear resistance and hardness, making such PCD materials extremely useful in aggressive wear and cutting applications where high levels of wear resistance and hardness are desired.

The metal catalyst, such as cobalt, used to promote recrystallization of the diamond particles and formation of the lattice structure of polycrystalline diamond may be leached to form thermally stable polycrystalline diamond. Examples of “leaching” processes can be found, for example, in U.S. Pat. Nos. 4,288,248 and 4,104,344. Briefly, a strong acid, such as hydrofluoric acid or combinations of several strong acids, may be used to treat the diamond table, removing at least a portion of the catalyst from the PDC composite. Suitable acids include, for example, nitric acid, hydrofluoric acid, hydrochloric acid, sulfuric acid, phosphoric acid, perchloric acid, or combinations of these acids. In addition, caustics, such as sodium hydroxide and potassium hydroxide, have been used by the carbide industry to digest metallic elements from carbide composites. In addition, other acidic and basic leaching agents may be used as desired. Those having ordinary skill in the art will appreciate that the molarity of the leaching agent may be adjusted depending on the time desired to leach, concerns about hazards, etc.

In some embodiments, only a select portion of a diamond composite is leached, e.g., to gain thermal stability without losing significant impact resistance. As used herein, the term TSP includes both of the above (i.e., partially and completely leached) PCD layers. Interstitial volumes remaining after leaching may be reduced by either furthering consolidation or by filling the volume with a secondary material, such as by processes known in the art and described in U.S. Pat. No. 5,127,923.

In some embodiments, TSP may be formed by forming the diamond layer in a press using a binder other than cobalt, one such as silicon, which has a coefficient of thermal expansion more similar to that of diamond than cobalt has. During the manufacturing process, a large portion, 80 to 100 volume percent, of the non-catalyst binder may react with the diamond lattice to form a carbide, such as silicon carbide when using a silicon non-catalyst binder, which may also have a thermal expansion similar to diamond. One of ordinary skill in the art would recognize that a thermally stable diamond layer may also be formed by other methods known in the art, including, for example, by altering processing conditions in the formation of the diamond layer, such as by increasing the pressure to above 50 kbars with a temperature of above 1350 degrees C.

Diamond grade (i.e., diamond powder composition including grain size and/or metal content) may be substantially uniform or may be varied within a diamond layer to form the cutting end of a cutting element. For example, in one or more embodiments, the region of diamond layer adjacent the substrate may differ in material properties (and diamond grade) as compared with the region of the diamond layer at the apex of a non-planar cutting element. Such variation may be formed by one or more step-wise layers or by a gradual transition.

According to embodiments of the present disclosure, cutting elements may be disposed in one or more rows on a blade of a downhole cutting tool, extending substantially radially outward from the blade outermost surface, where at least two adjacent cutting elements in a row have different axial lengths. Rows of cutting elements having at least two adjacent cutting elements with different axial lengths may include an increased amount of cutting elements when compared to a row having cutting elements with equal axial lengths. For example, FIG. 8 shows a profile of a high density row of cutting elements 810 having at least two adjacent cutting elements with different axial lengths 812, 814 superimposed on a profile of a low density row of cutting elements 820 (represented by the dashed outlines) having equal axial lengths 822, where cutting elements 810 and 820 extend radially outward from a blade outermost surface 830 and are disposed in two selected regions 840, 842 of the blade. For purposes of comparison, cutting elements 810 and 820 have equal diameters, equal exposure heights 816, 826 (i.e., distance from the outermost surface 830 to the radially most distal point of the cutting element), and equal axial lengths 812 and 822, while cutting elements 810 with axial lengths 814 are shorter than axial lengths 812 and 822. As shown, cutting elements 820 having equal axial lengths 822 and forming the low density row are spaced farther apart than cutting elements 810 having different axial lengths that form the high density row, where the material forming the blade on which cutting elements 810, 820 are disposed surround the entire base end (axially opposite the exposed cutting end) of each of the cutting elements 810, 820. The number of cutting elements 810, 820 in the first selected region 840 of the blade remains the same in both the high density row and the low density row, while the number of high density row cutting elements 810 in the second selected region 842 is greater than the number of low density row cutting elements 820 in the second selected region 842 by about half of a cutting element. As used herein, a “high density row” may refer to a row of cutting elements extending substantially radially outward from an outermost surface of a blade with at least two adjacent cutting elements having different axial lengths, where the term “high density row” is relative to a comparative “low density row” of cutting elements extending substantially radially outward from an outermost surface of a blade and having equal axial lengths.

According to embodiments of the present disclosure, a shortest cutting element (e.g., cutting elements 810 having an axial length 814) of at least two adjacent cutting elements in a high density row may have a difference in axial length from a longest cutting element (e.g., cutting elements 810 having an axial length 812) of the at least two adjacent cutting elements that is greater than 5 percent of the axial length of the longest cutting element. In some embodiments, the difference in axial length between a shortest cutting element and a longest cutting element in a high density row may range between 5 and 35 percent of the axial length of the longest cutting element, between 8 and 25 percent of the axial length of the longest cutting element, or between 10 and 15 percent of the axial length of the longest cutting element. In some embodiments, the difference in axial length between a shortest cutting element and a longest cutting element in a high density row may range from a lower limit of 0.04 in (1 mm), 0.05 in (1.3 mm), 0.08 in (2 mm) or 0.12 in (3 mm) to an upper limit of 0.08 in (2 mm), 0.12 in (3 mm), 0.15 in (3.8 mm), 0.18 in (4.6 mm) or 0.2 in (5 mm), where any lower limit may be used in combination with any upper limit, depending on, for example, the diameter of the cutting elements and the axial length of the longest cutting element. In one or more embodiments, the diameter of a cutting element may generally range from 9 mm to 22 mm, such as 9 mm, 11 mm, 13 mm, 16 mm, 19 mm, or 22 mm.

Further, in the embodiment shown, cutting elements 810 and 820 have an exposed portion 850 extending an exposure height 816, 826 from the outermost surface 830 of the blade, where the exposure heights 816 and 826 are substantially equal. According to embodiments of the present disclosure, a high density row of cutting elements may include at least two adjacent cutting elements with different axial lengths, where the at least two adjacent cutting elements have the same exposure height. According to some embodiments, a high density row of cutting elements may include at least two adjacent cutting elements with different axial lengths, where the exposure height of the at least two adjacent cutting elements have different exposure heights. In such embodiments, the adjacent cutting elements having different exposure heights and different axial lengths may be positioned on the blade such that the base end of the cutting elements are disposed at different distances below the outermost surface of the blade.

Methods of making downhole cutting tools according to embodiments of the present disclosure may include attaching at least three cutting elements to at least one blade extending a height from a tool body to an outermost surface, where the at least three cutting elements are oriented to extend substantially outward (e.g., substantially radially outward) from the outermost surface (e.g., top surface) of the at least one blade and are oriented in a row, and where the at least two adjacent cutting elements have a difference in axial length. The cutting elements may be attached to the blade(s) by inserting each of the cutting elements into a pocket formed in the at least one blade and brazing each of the cutting elements to the pocket. The difference in axial length may be designed based on a calculated reduction in distance between the at least two adjacent cutting elements. For example, a comparison distance along the outermost surface of a blade between adjacent comparison cutting elements (between the closest points of the adjacent comparison cutting elements along the outermost surface of the blade) may be calculated, where each comparison cutting element has an equal axial length. The axial lengths of the comparison cutting elements may be equal to the axial length of the longest cutting element that will be used in the high density row being designed. The difference in axial length of the at least two adjacent cutting elements forming the high density row may then be selected to reduce the distance between the at least two adjacent cutting elements along the outermost surface by about 5 to 20 percent from the comparison distance. For example, referring again to FIG. 8, cutting elements 820 may be used as comparison cutting elements to calculate a comparison distance 860 along a blade outermost surface 830 between adjacent cutting elements 820 having equal axial lengths (also equal to the longest axial length of cutting elements 810). The difference in axial length between an adjacent shortest cutting elements 810 (having an axial length 814) and an adjacent longest cutting element 810 (having an axial length 812) may be selected to reduce the comparison distance by 5 to 20 percent. In other words, the difference in axial length between adjacent cutting elements 810 may be selected such that the distance 870 along the outermost surface 830 of the blade between the adjacent cutting elements 810 is 5 to 20 percent less than the comparison distance 860.

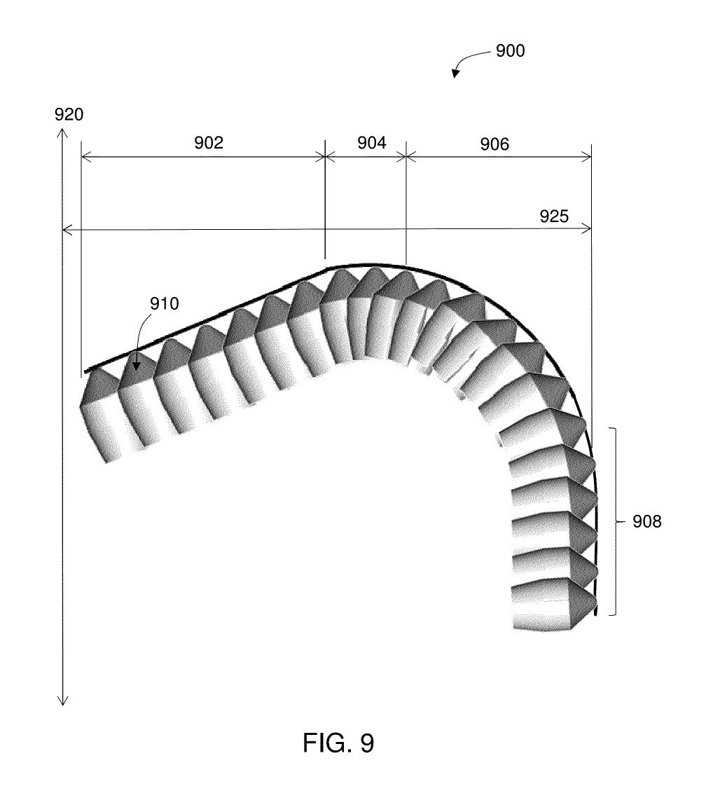

Adjacent cutting elements with different axial lengths forming at least a portion of a high density row of cutting elements may be disposed on selected regions of a blade. For example, FIG. 9 shows a cutting profile 900 of a drill bit having a plurality of cutting elements 910 disposed on a plurality of blades rotated into a single plane. The cutting profile 900 includes a cone region 902, a nose region 904, a shoulder region 906, and a gage region 908. The cone region 902 is the radially innermost region of bit (e.g., cone region 902 is the central most region of bit) and profile 900, extending generally from the bit axis 920 to a nose region 904. In some embodiments, the cone region 902 may be a generally concave portion of the blade. Adjacent the cone region 902 is a nose region 904, which may generally refer to the point where the slope of the blade changes from concave to convex. In other words, when referring to regions of a bit cutting profile, the term “nose region” may refer to the point along a convex region of a composite blade profile of a bit in rotated profile view at which the slope of a tangent to the composite blade profile is zero. Adjacent the nose region 904 is the shoulder region 906, which has a convex or upturned curved shape. In most fixed cutter bits, the shoulder region 906 is generally the convex region of the blade. Moving radially outward, adjacent the shoulder region 906 is the gage region 908, which extends parallel to the bit axis at the outer radial periphery 925 of cutting profile 900. Thus, the gage region 908 may be referred to as the portion of the cutting profile 900 at the full gage diameter of bit. The cone region 902 is defined by a radial distance along the x-axis measured from central axis 920, where the x-axis is perpendicular to central axis 920 and extends radially outward from central axis 920. The cone region 902 may be defined by a percentage of the outer radius 925 of the bit. The actual radius of cone region 902, measured from central axis 920, may vary from bit to bit depending on a variety of factors including without limitation, bit geometry, bit type, location of one or more secondary blades, location of trailing cutting elements, or combinations thereof. For most fixed cutter bits, the cutting profile includes a single convex shoulder region on a blade (e.g., convex shoulder region 906), and a single blade profile nose (e.g., nose region 904). Further, in most fixed cutter drill bits, the nose region and shoulder region of the cutting profile may have the sharpest radius of curvature when compared with other regions of the cutting profile.

Other downhole cutting tools of the present disclosure may have different cutting profile shapes and curvatures. For example, a downhole cutting tool may have a cutting profile formed by a plurality of cutting elements disposed in one or more high density rows on a plurality of blades and rotated into a single plane. The cutting profile may include one or more convex regions having a sharper radius of curvature than the remaining regions of the cutting profile, where a region of a cutting profile may be defined along a distance of the cutting profile large enough to include at least one entire cutting element. In some embodiments, a cutting profile may include one or more regions along the tallest portions of the blades (i.e., measured by the blade height, from the tool body to the blade outermost surface). In one or more embodiments, a tallest region of a blade may also be a convex region.

According to some embodiments of the present disclosure, at least two adjacent cutting elements having different axial lengths in a high density row may be disposed in one or more convex regions of the blade cutting profile. In some embodiments of the present disclosure, at least two adjacent cutting elements having different axial lengths in a high density row may be disposed in one or more tallest regions of the blade cutting profile. In some embodiments, at least two adjacent cutting elements having different axial lengths in a high density row may be disposed in at least one of a nose region or a shoulder region of a blade cutting profile. For example, referring back to FIG. 8, at least two adjacent cutting elements 810 in a high density row having different axial lengths 812, 814 may be disposed in a second region 842 of a blade having a convex shape, where the region 842 may be the shoulder region of the blade on a drill bit cutting tool.

An increased number of cutting elements in a row of radially outwardly extending cutting elements may fit in one or more regions of a blade by varying the axial length of at least two adjacent cutting elements of the row. For example, an increased number of cutting elements in a row of radially outwardly pointing cutting elements may fit in the nose region and the shoulder region of a blade by varying the axial length of at least two adjacent cutting elements of the row.

According to embodiments of the present disclosure, a downhole cutting tool may have a tool body, a plurality of blades extending a height from the tool body to an outermost surface (e.g., top surface), and an increased number of cutting elements in a row of radially outwardly extending cutting elements in one or more regions of at least one of the blades. The height of each blade along a length of the blade defines a height-dimension plane, and the dimension between a leading face and a trailing face of the blade defines its width, where the leading face faces in the direction of the rotation of the cutting tool and the trailing face is opposite the leading face. A plurality of cutting elements may be disposed on the plurality of blades and oriented substantially radially outward from the outermost surface of the blades, where a rotated view of the plurality of cutting elements into a single plane forms a cutting profile including a cone region, a nose region, a shoulder region, and a gage region. At least one row of cutting elements including at least three of the radially outward facing cutting elements may be disposed on the outermost surface (e.g., top surface) of one of the blades, where a row of cutting elements is defined by a straight line intersecting the longitudinal axes of each cutting element in the row. The row of cutting elements may extend in a single direction along the length of the blade defined along a straight line intersecting the longitudinal axes of each cutting element in the row.

FIG. 21 shows a profile of a high density row of cutting elements 2110 having at least two adjacent cutting elements with different axial lengths, where cutting elements 810 extend radially outward from a blade top surface and are located in a shoulder region 2142 of the blade. Each row of cutting elements may have a cutting row density equal to the cumulative diameter of cutting elements in the row divided by the length of the blade on which a row is disposed, measured along the outermost surface in one or more selected regions of the blade (e.g., the nose and shoulder region). For example, as shown in FIG. 21, the cutting row density of shoulder region 2142 is the sum of the diameters 2180 (e.g., the cumulative diameters) of the cutting elements 2110 (D_{cutters}) in the shoulder region 2142 divided the length of the blade 2182 (L_{blade}) in the shoulder region 2141 or D_{cutters}/L_{blade}. According to some embodiments, the cumulative diameters of the cutting elements forming the row (D_{cutters}) in the length of the blade in the selected region(s) over the length of the blade in the selected region(s) (L_{blade}) (or cutting row density) may be greater than 50 percent, greater than 65 percent, or greater than 75 percent. In some embodiments, the cutting row density may be between 80 and 95 percent.

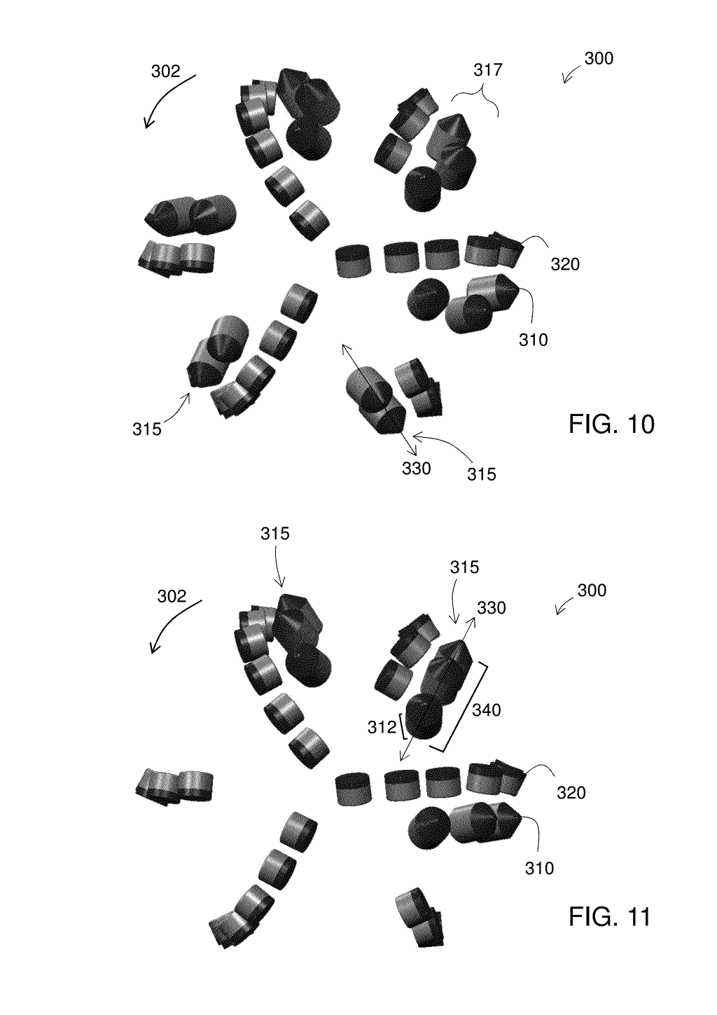

FIGS. 10 and 11 show the placement and orientation of cutting elements on a drill bit cutting tool having a plurality of blades extending a height from the tool body (not shown) to an outermost surface. The cutting elements include non-planar cutting elements 310 oriented substantially radially outward from the outermost surface of the blades (not shown) and cutters 320 oriented such that a planar cutting face of each cutter is facing in the direction of the bit rotation 302. At least three non-planar cutting elements 310 are disposed in a row 315 on the outermost surface of at least one of the blades, where the row 315 is defined by a straight line 330 intersecting the longitudinal axes of each cutting element 310 in the row. As shown in FIG. 10, some blades may have a non-linear arrangement 317 of non-planar cutting elements 310, while other blades may have a linear arrangement of non-planar cutting elements 310 forming rows 315. A row of cutters 320 may be disposed at the cutting edge (intersection of the outermost surface or top surface and leading face) of each blade. According to embodiments of the present disclosure, a bit may have one or more blades with a single row of cutting elements thereon or one or more blades with two or more rows of cutting elements thereon. For example, as shown in FIGS. 10 and 11, some blades may have a single row of cutters 320, while other blades may have a row 315 of non-planar cutting elements and a row of cutters 320 on each blade. In some embodiments, two or more rows of the same type of cutting elements (e.g., non-planar cutting elements 310) may be disposed on a single blade.

By arranging cutting elements in one or more rows, the blade on which the row(s) are disposed may have a reduced width when compared with blades having one or more non-linear arrangements of cutting elements. For example, the blades retaining the non-linear arrangement 317 of cutting elements 310 shown in FIG. 10 have a greater width than the blades retaining the rows 315 of cutting elements 310 shown in FIG. 11. Bits or other cutting tools having blades with a reduced width may have more blades spaced around the tool body, or may have an increased space between the blades, thereby providing better flow of drilling fluid and/or cuttings between the blades.

Referring again to FIG. 11, rows 315 of non-planar cutting elements 310 may each have a cutting row density equal to the cumulative diameters 312 of the non-planar cutting elements 310 forming the row divided by a length 340 of the blade on which the row 315 is disposed, measured along the outermost surface in one or more selected regions of the blade (e.g., the nose region, the shoulder region, or the nose and shoulder region). The cutting row density of the cutting elements forming the row in the selected region(s) of the blade may range from a lower limit of 50, 65, 75, 80 or 85 percent to an upper limit of 80, 85, 90 or 95 percent, where any lower limit may be selected in combination with any upper limit. Such an increased cutting element density may be present in one or more selected regions of a blade by having at least two adjacent cutting elements in the high density row with, for example, different axial lengths or different grip region geometries, such as tapered substrates, stepped geometries with a smallest diameter at the base and incrementally increased diameters along the axial direction (either with a smooth or discontinuous increase along the axial direction), or substrates having a cross sectional shape with at least one planar side surface (and e.g., planar side surfaces of adjacent cutting elements may face each other), or a combination of different axial lengths and different grip region geometries. In particular embodiments, a row of cutting elements oriented along a blade with their longitudinal axes pointing substantially radially outward from the blade outermost surface may have an increased cutting element density (e.g., having a cutting element density ranging from 65 to 95 percent) by including at least two adjacent cutting elements with different axial lengths and/or different grip region geometries in a region of the blade having a convex shape, e.g., a nose and/or shoulder region of a blade, or other region of a blade having a sharper radius of curvature when compared with the remaining regions of the blade.

According to some embodiments, the number of cutting elements forming a high density row in the nose region and/or the shoulder region of at least one blade may range from a lower limit of 4, 4.5, 5 or 5.5 cutting elements to an upper limit of 5, 5.5, 6, 6.5, 7, 7.5 or 8 cutting elements, where any lower limit may be used in combination with any upper limit. As used herein, a fraction of a cutting element may refer to the fraction of its diameter, e.g., 5.5 cutting elements represent 5 cutting element diameters and a radius of a cutting element disposed within the selected blade region(s). The number of cutting elements in a high density row of cutting elements on a blade may depend on, for example, the diameter of the cutting elements and the length of the blade region(s). Further, cutting elements forming a high density row of cutting elements may be designed and placed on a blade to have an increased number of cutting elements form the row according to embodiments of the present disclosure, such that the material forming the blade on which the cutting elements are disposed surround the entire base end or substrate region of each cutting element. In other words, according to embodiments of the present disclosure, a high density row of cutting elements may have an increased number of cutting elements forming the row in addition to having none of the cutting elements contacting each other.

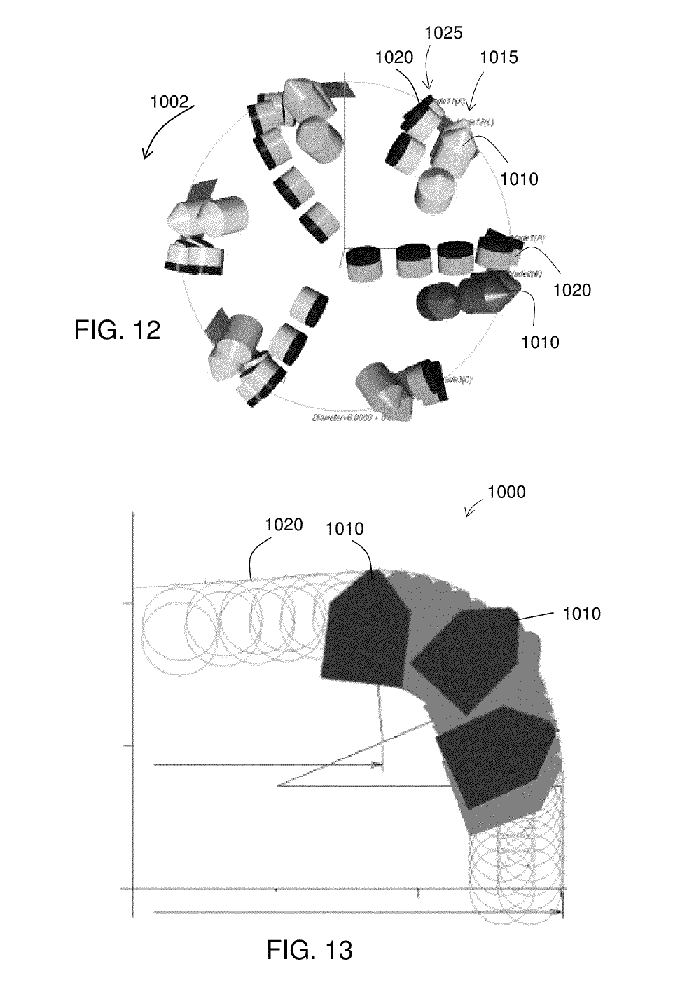

FIGS. 12 and 13 show another example of a downhole cutting tool according to embodiments of the present disclosure. FIG. 12 shows a top view of cutting element placement and orientation on a drill bit having a plurality of blades extending a height from the bit body, where rows of cutting elements are disposed on each of the blades. Particularly, a primary row 1025 of cutters 1020 are disposed along a cutting edge of each blade, and a trailing row 1015 of non-planar cutting elements 1010 are disposed in the trailing position to each primary row 1025 on each blade. FIG. 13 shows the cutting profile 1000 of the cutting tool shown in FIG. 12 as it would appear with each cutting element 1010, 1020 rotated into a single rotated profile. Non-planar cutting elements 1010 are oriented on each blade substantially radially outward from the outermost surface of each blade. At least two of the non-planar cutting elements 1010 in each trailing row 1015 have different axial lengths and are placed in the nose and shoulder regions of each blade, such that an increased number of non-planar cutting elements 1010 may fit within the nose and shoulder regions of the blades.

A downhole cutting tool according to embodiments of the present disclosure may be made by attaching at least three cutting elements to at least one blade extending a height from a tool body to an outermost surface, such that the cutting elements extend substantially radially outward from the outermost surface of the at least one blade and are oriented in a row. At least two of the cutting elements may have different axial lengths. Each of the at least three cutting elements may be attached to a blade in a row by inserting each cutting element into a pocket formed in the blade and brazing each cutting elements to the pocket. In other embodiments, the pockets may extend equal depths into the blade. In some embodiments, other means of attachment may be used, such as interference fitting or mechanical retention. Further, in some embodiments, at least two of the pockets may extend different depths into the blade, where upon inserting the cutting elements with different axial lengths into the pockets with different depths, the cutting elements with different axial lengths extend substantially equal exposure heights above the blade outermost surface (e.g., top surface).

Cutting elements may be formed to have different axial lengths by forming substrates with different axial lengths, forming an ultrahard material body to have a different axial length, or by forming both the substrate and ultrahard material body to have different axial lengths than that of an adjacent cutting element. For example, a first and second non-planar cutting element may each have substrates with different axial lengths and diamond bodies with different axial lengths, where the first and second non-planar cutting elements have different total axial lengths and may be disposed adjacent to each other in a row on a blade, oriented to point radially outward from the outermost surface of the blade. Cutting elements having different total axial lengths may also have different component axial lengths when one component axial length is designed to accommodate characteristics from another component's change in axial length, for example, a substrate axial length may be increased to provide better support for a diamond body having an increased axial length.

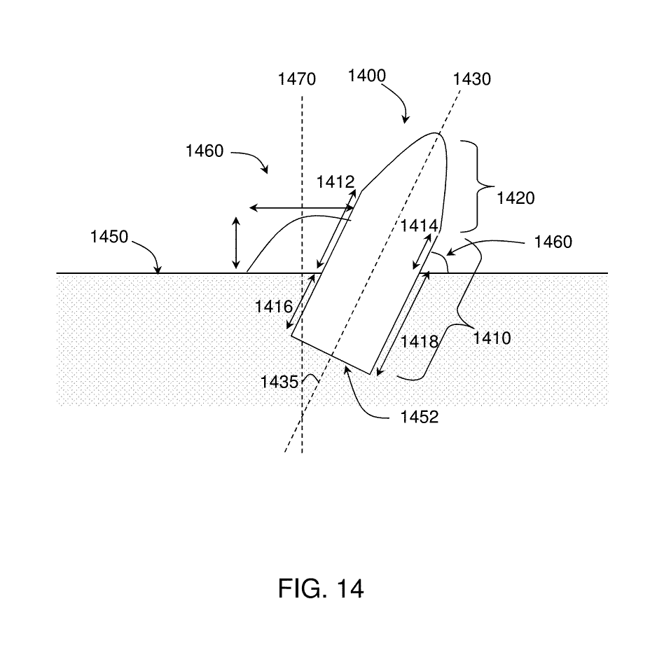

Cutting elements extending substantially radially outward from the outermost surface of a blade may have a support disposed at least partially around its outer perimeter to improve the cutting element stability and retention to the blade. The support may be attached to the outermost surface of the blade or may be integrally formed with the blade as a protrusion extending at least partially around one or more pockets. For example, a cross-sectional view of a non-planar cutting element 1400 disposed on a blade 1450 at an angle relative to the surrounding blade outermost surface is shown in FIG. 14. The non-planar cutting element 1400 has a grip region 1410, a non-planar cutting end 1420 having an apex with a radius of curvature, and a longitudinal axis 1430 extending axially through the non-planar cutting element from a base of the grip region and through the apex. The non-planar cutting element 1400 is disposed within a pocket 1452 formed in the blade 1450 and oriented such that the longitudinal axis 1430 is at an angle 1435 with respect to a line 1470 normal to the blade 1450 outermost surface and extending at least partially through the non-planar cutting element 1400. The area 1412 of the grip region outside the pocket 1452 on a first side is larger than the area 1414 of the grip region outside the pocket 1452 on an opposite side. Likewise, the area 1416 of the grip region within the pocket 1452 and on the first side is smaller than the area 1418 of the grip region within the pocket 1452 on the opposite side. In embodiments where angle 1435 is zero (the longitudinal axis is parallel to the line normal to the blade outermost surface), the areas 1412, 1414 of the grip region outside the pocket may be equal.

A support 1460 extends circumferentially around a portion of the grip region outside the pocket 1452. As shown, the support 1460 may be applied around the grip region having a varied axial length along the grip region 1410, measured from the outer surface of the blade 1450 (at the opening to the pocket) to an exposed portion of the grip region 1410. Thus, although the areas 1412, 1414 outside the pocket 1452 on opposite sides have different axial lengths, the varied axial length of coverage of the support 1460 may provide an exposed portion of the grip region having a substantially uniform exposure length around the grip region. However, according to other embodiments of the present disclosure, both the axial length of the support and the exposure length of the exposed portion may vary around at least a portion of the circumference of the grip region. In yet other embodiments, a support may have a substantially uniform axial length and an exposed portion may have a varied exposure length around at least a portion of the circumference of the grip region.

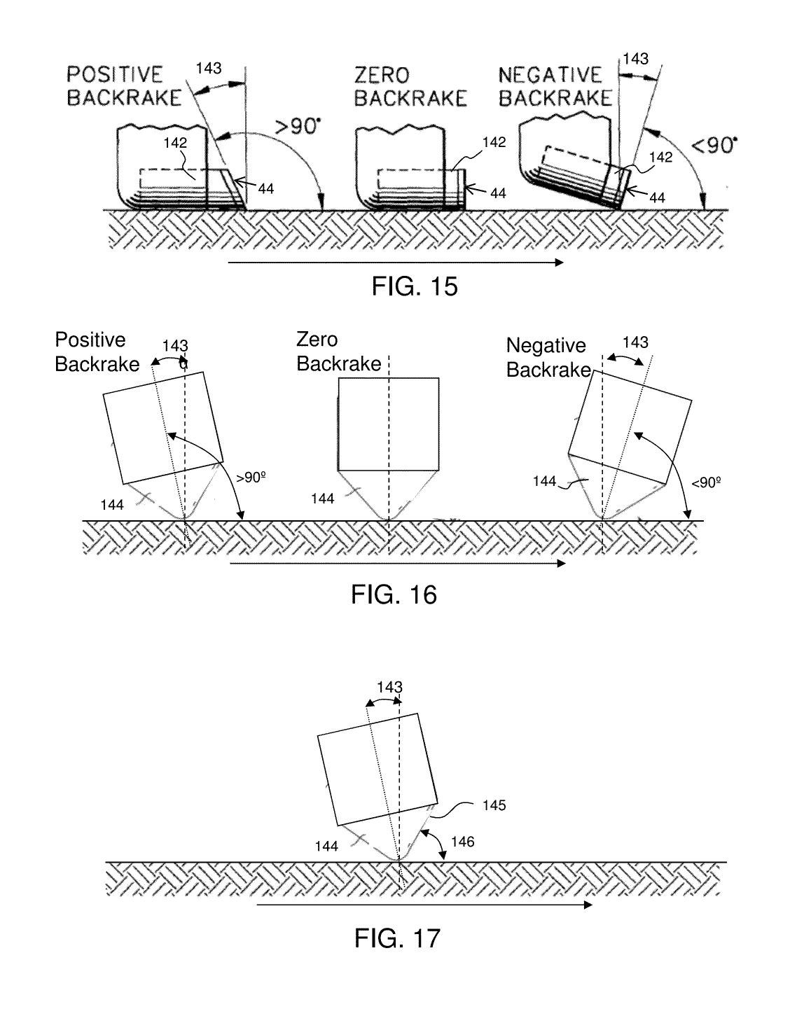

The cutting elements of the present disclosure may be oriented at a back rake and/or side rake. Generally, when positioning cutting elements on a blade of a bit or reamer, the cutting elements may be inserted into cutter pockets (or holes) to change the angle at which the cutting element strikes the formation. Specifically, the back rake (i.e., a vertical orientation) and the side rake (i.e., a lateral orientation) of a cutting element may be adjusted. Generally, backrake of a cutter is defined as the angle formed between the cutting face of the cutter and a line that is normal to the formation material being cut. As shown in FIG. 15, with a conventional cutter 142 having zero backrake, the cutting face 44 is substantially perpendicular or normal to the formation material. A cutter 142 having negative backrake angle 143 has a cutting face 44 that engages the formation material at an angle that is less than 90° as measured from the formation material. Similarly, a cutter 142 having a positive backrake angle 143 has a cutting face 44 that engages the formation material at an angle that is greater than 90° when measured from the formation material.

However, non-planar cutting elements do not have a planar cutting face and thus the orientation of non-planar cutting elements are defined differently. When considering the orientation of non-planar cutting elements, in addition to the vertical or lateral orientation of the cutting element body, the pointed geometry of the cutting end also affects how and the angle at which the non-planar cutting element strikes the formation. Specifically, in addition to the backrake affecting the aggressiveness of the non-planar cutting element-formation interaction, the cutting end geometry (e.g., the apex angle and radius of curvature) affects the aggressiveness that a non-planar cutting element attacks the formation. Thus, in the context of a non-planar cutting element backrake orientation, backrake may be defined as an angle formed between the longitudinal axis of the non-planar cutting element and a line normal to the blade profile of the blade where the non-planar cutting element is disposed, as described above. In some embodiments, as shown in FIG. 16, backrake of a non-planar cutting element may be defined as the angle 143 formed between the axis of the non-planar cutting element 144 (specifically, the axis of the non-planar cutting end) and a line that is normal to the formation material being cut. As shown in FIG. 16, with a non-planar cutting element 144 having zero backrake, the axis of the non-planar cutting element 144 is substantially perpendicular or normal to the formation material. A non-planar cutting element 144 having negative backrake angle has an axis that engages the formation material at an angle that is less than 90° as measured from the formation material. Similarly, a non-planar cutting element 144 having a positive backrake angle has an axis that engages the formation material at an angle that is greater than 90° when measured from the formation material. In a particular embodiment, the backrake angle of the non-planar cutting elements may be zero, or in another embodiment may be negative. In a particular embodiment, the backrake of the non-planar cutting elements may range from −30 to 30 degrees, from −20 to 20 degrees, from −10 to 10 degrees, from zero to 10 degrees, and from −5 to 5 degrees in some embodiments.

In addition to the orientation of the axis with respect to the formation, the aggressiveness of a non-planar cutting element may also be dependent on the leading angle or specifically, the angle between the formation and the leading portion of the non-planar cutting element. The cutting end shape of the non-planar cutting elements does not have a leading edge; however, the leading line of a non-planar cutting surface may be determined to be the first most points of the non-planar cutting element at each axial point along the non-planar cutting end surface as the bit rotates. Said in another way, a cross-section may be taken of a non-planar cutting element along a plane in the direction of the rotation of the bit, as shown in FIG. 17. The leading line 145 of the non-planar cutting element 144 in such plane may be considered in relation to the formation. The strike angle of a non-planar cutting element 144 is defined to be the angle 146 formed between the leading line 145 of the non-planar cutting element 144 and the formation being cut.

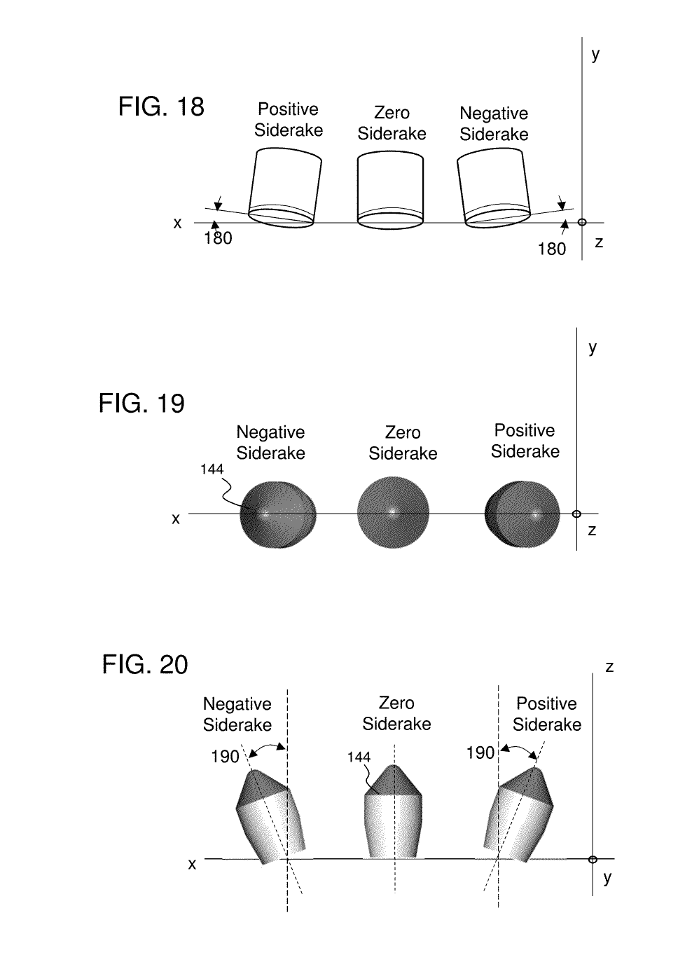

Side rake is defined for cutters as the angle between the cutting face and the radial plane of the bit (x-z plane), as illustrated in FIG. 18. When viewed along the z-axis, a negative side rake angle 180 results from counterclockwise rotation of the cutter, and a positive side rake angle 180, from clockwise rotation. In a particular embodiment, the side rake of cutters may range from −30 to 30 degrees, and from 0 to 30 degrees in other embodiments.

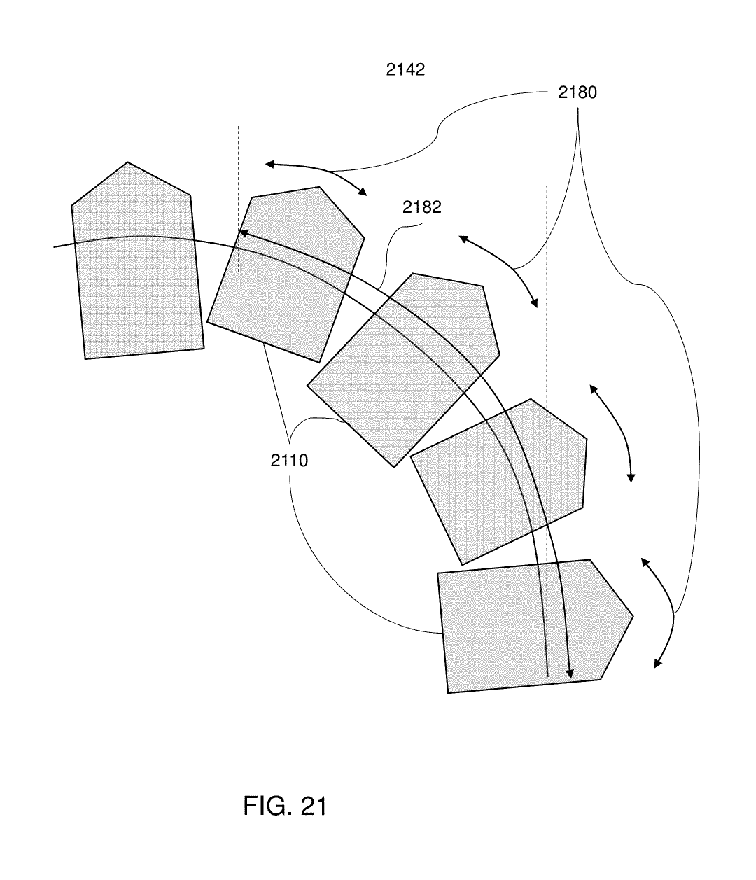

In the context of a non-planar cutting element, as shown in FIGS. 19 and 20, side rake is defined as the angle 190 formed between the axis of the non-planar cutting element 144 (specifically, the axis of the conical cutting end) and a line parallel to the bit centerline, i.e., z-axis. As shown in FIGS. 19 and 20, with a non-planar cutting element 144 having zero side rake, the axis of the non-planar cutting element 144 is substantially parallel to the bit centerline. A non-planar cutting element 144 having negative side rake angle 190 has an axis that is pointed away from the direction of the bit centerline. Conversely, a non-planar cutting element 144 having a positive side rake angle 190 has an axis that points towards the direction of the bit centerline. The side rake of the non-planar cutting elements may range from about −30 to 30 in various embodiments and from −10 to 10 in other embodiments. Further, while not necessarily specifically mentioned in the above paragraphs, the side rake angles of the non-planar cutting elements in the embodiments disclosed herein may be selected from these ranges.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. Changes that come within the meaning and range of equivalency of the claims are to be embraced within their scope.

What is claimed is:

1. A downhole cutting tool, comprising:
a tool body;
a plurality of blades extending a height from the tool body to an outermost surface; and
a plurality of cutting elements disposed along at least one of the plurality of blades, each cutting element having a longitudinal axis oriented substantially radially outward from the outermost surface of the blade,
at least two adjacent cutting elements of the plurality of cutting elements having different axial lengths.

2. The downhole cutting tool of claim 1, wherein a rotated view of the plurality of cutting elements into a single plane forms a cutting profile including one or more convex regions, the at least two adjacent cutting elements of the plurality of cutting elements being in at least one of the convex regions.

3. The downhole cutting tool of claim 1, wherein the plurality of cutting elements have a non-planar cutting end.

4. The downhole cutting tool of claim 1, wherein a shortest cutting element of the at least two adjacent cutting elements of the plurality of cutting elements has a difference in axial length from a longest cutting element of the at least two adjacent cutting elements of the plurality of cutting elements of at least 5 percent of the axial length of the longest cutting element.

5. The downhole cutting tool of claim 4, wherein the difference in axial length is between 8 and 15 percent of the axial length of the longest cutting element.

6. The downhole cutting tool of claim 1, wherein each of the plurality of cutting elements has an exposed portion extending an exposure height from the outermost surface of the blade, and wherein the exposure height of the at least two adjacent cutting elements is the same.

7. The downhole cutting tool of claim 1, wherein each of the plurality of cutting elements has an exposed portion extending an exposure height from the outermost surface of the blade, and wherein the exposure height of the at least two adjacent cutting elements is different.

8. The downhole cutting tool of claim 1, wherein the plurality of cutting elements form one or more rows of the cutting elements on the plurality of blades.

9. The downhole cutting tool of claim 1, wherein at least one of the plurality of blades has a leading row of primary cutting elements and a trailing row comprising at least three cutting elements of the plurality of cutting elements positioned along the outermost surface of the blade.

10. The downhole cutting tool of claim 9, wherein the leading row of primary cutting elements is positioned along a cutting edge of the blade, and at least one of the primary cutting elements comprises a planar cutting face.

11. The downhole cutting tool of claim 1, wherein the downhole cutting tool is a fixed cutter drill bit.

12. A downhole cutting tool, comprising:
a tool body;
a plurality of blades extending a height from the tool body to an outermost surface;
a plurality of cutting elements disposed on the plurality of blades, each cutting element having a longitudinal axis oriented substantially radially outward from the outermost surface of the blades, a rotated view of the plurality of cutting elements into a single plane forming a cutting profile including a cone region, a nose region, a shoulder region, and a gage region; and
at least one row of cutting elements, each row of cutting elements comprising at least three of the plurality of cutting elements on the outermost surface of at least one blade, the at least one row of cutting elements defined by a straight line intersecting the longitudinal axes of each cutting element in the row,
each of the at least one row of cutting elements having a cutting row density equal to a cumulative diameter of the cutting elements forming the row in at least one region divided by a length of the at least one blade measured along the outermost surface of the at least one region;
the cutting row density being greater than 65 percent.

13. The downhole cutting tool of claim 12, wherein the plurality of cutting elements have a non-planar cutting end.

14. The downhole cutting tool of claim 12, wherein each of the plurality of cutting elements is oriented at a back rake angle of −30 to 30 degrees.

15. The downhole cutting tool of claim 12, wherein at least two adjacent cutting elements of the at least one row have different axial lengths.

16. The downhole cutting tool of claim 12, wherein at least one of the blades further comprises a leading row of primary cutting elements positioned along a cutting edge of the blade.

17. The downhole cutting tool of claim 12, wherein the downhole cutting tool is a fixed cutter drill bit.

18. A method of manufacturing a downhole cutting tool, comprising:
attaching at least three cutting elements to at least one blade extending a height from a tool body to an outermost surface, the at least three cutting elements extending substantially radially outward from the outermost surface of the at least one blade and oriented in a row,
at least two adjacent cutting elements having a different axial length.

19. The method of claim 18, further comprising:
calculating a comparison distance along the outermost surface of the blade between adjacent comparison cutting elements, each comparison cutting element having an axial length equal to the longest axial length of the at least two adjacent cutting elements, and
selecting the difference in axial length to reduce a distance between the at least two adjacent cutting elements along the outermost surface by 5 to 20 percent from the comparison distance.

20. The method of claim 18, wherein attaching comprises inserting each of the at least three cutting elements into a pocket formed in the at least one blade and brazing each of the at least three cutting elements to the pocket.
